(19) United States
(12) Patent Application Publication
(10) Pub. No.: US 2008/0143732 A1
(43) Pub. Date: Jun. 19, 2008

(54) Data transfer apparatus

(75) Inventor: Seiya Shiozaki, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/981,107

(22) Filed: Oct. 31, 2007

(30) Foreign Application Priority Data
Nov. 9, 2006 (JP) 2006-304421

(51) Int. Cl. G06F 12/02

(52) U.S. Cl. 345/543

(57) ABSTRACT

In one embodiment, a predetermined amount of bitmap data is accumulated in a first cache memory, a predetermined amount of arrangement-converted bitmap data is accumulated in the second cache memory, the number of instances of switching between value 0 and value 1 when transferring/outputting bitmap data is compared to the number of instances of switching between value 0 and value 1 when transferring/outputting arrangement-converted bitmap data, and the bitmap data or the arrangement-converted bitmap data with the lesser number of instances of switching is transferred/output to a RAM; thus, the power consumption when transferring/outputting data to the RAM via a data bus is reduced.

### CROSS REFERENCE TO RELATED APPLICATIONS

This application claims priority under 35 U.S.C. § 119(a) on Japanese Patent Application No. 2006-304421 filed in Japan on Nov. 9, 2006, the entire contents of which are hereby incorporated by reference.

### BACKGROUND OF THE INVENTION

1. Field of Invention

The present invention relates to a data transfer apparatus that transfers/outputs bitmap data to a large capacity memory.

2. Related Art

As is commonly known, in a network system employing a LAN (Local Area Network) or the like, a personal computer, a printer, and the like are connected to a network, print data such as PDL (Page Description Language) data is transferred from the personal computer to the printer via the network, and the print data is recorded by the printer. Print data such as PDL data is used for printing after being converted to bitmap data, and this data conversion is performed with a printer controller (for example, see JP H10-52965A).

In the printer controller, for example, an SOC (System On Chip) is used, and while converting the PDL data to bitmap data with the SOC, and after temporarily accumulating the bitmap data a predetermined amount at a time in a cache memory of the SOC, the data is transferred/output to a large capacity memory external to the SOC, and thus the bitmap data is accumulated in the large capacity memory. Further, the bitmap data is read out from the large capacity memory and transferred to a printer engine, and images, text, or the like expressed by the bitmap data are printed on recording paper with the printer engine.

Incidentally, in the printer controller, although a small amount of power consumption is needed in order to perform writing and reading out of the bitmap data to the cache memory of the SOC, in comparison to this power consumption, a very large amount of power consumption is needed in order to transfer the bitmap data from the cache memory of the SOC to a large capacity memory external to the SOC. This is because data transfer to the large capacity memory external to the SOC is performed via a data bus. Furthermore, because the amount of bitmap data is large, it is desirable to achieve a reduction in this power consumption.

### SUMMARY OF THE INVENTION

It is an object of the present invention to provide a data transfer apparatus in which it is possible to reduce power consumption when bitmap data is transferred to a large capacity memory.

The data transfer apparatus of the present invention is a data transfer apparatus that transfers bitmap data that is a collection of binary data to a large capacity memory, the data transfer apparatus being provided with: a first memory in which a predetermined amount of the bitmap data is accumulated; a second memory in which arrangement-converted bitmap data is accumulated, the arrangement-converted bitmap data being obtained by, for each of a data arrangement in an X direction in the predetermined amount of bitmap data, rearranging the data arrangement from the X direction to a Y direction; a calculation portion that obtains a first number of instances of switching between a value 0 and a value 1 when transferring bitmap data in the first memory, and obtains a second number of instances of switching between the value 0 and the value 1 when transferring arrangement-converted bitmap data in the second memory; and a transfer portion that, of the first number of instances of switching for the bitmap data in the first memory and the second number of instances of switching for the arrangement-converted bitmap data in the second memory that were obtained by the calculation portion, selects the lesser number of instances of switching, and transfers the bitmap data or the arrangement-converted bitmap data having the lesser number of instances of switching to the large capacity memory.

Also, the data transfer apparatus of the present invention may be a data transfer apparatus that transfers bitmap data that is a collection of binary data to a large capacity memory, the data transfer apparatus being provided with: a first memory in which a predetermined amount of the bitmap data is accumulated; a second memory in which inverted bitmap data is accumulated, the inverted bitmap data being obtained by inverting a value 0 and a value 1 in the predetermined amount of bitmap data; a calculation portion that obtains a first number of values 0 in the bitmap data in the first memory and a second number of values 0 in the inverted bitmap data in the second memory; and a transfer portion that, of the first number of values 0 in the bitmap data in the first memory and the second number of values 0 for the inverted bitmap data in the second memory that were obtained by the calculation portion, selects the lesser number of values 0, and transfers the bitmap data or the inverted bitmap data having the lesser number of values 0 to the large capacity memory.

Alternatively, the data transfer apparatus of the present invention may be a data transfer apparatus that transfers bitmap data that is a collection of binary data to a large capacity memory, the data transfer apparatus being provided with: a first memory in which a predetermined amount of the bitmap data is accumulated; an inverter portion that inverts a value 0 and a value 1 in the predetermined amount of bitmap data; a calculation portion that obtains a number of values 0 in the bitmap data in the first memory; and a transfer portion that, when the number of values 0 in the bitmap data in the first memory obtained by the calculation portion is 50% or more of the total number of values 0 and values 1 in the bitmap data, transfers the bitmap data in the first memory to the large capacity memory via the inverter portion, and when the number of values 0 is less than 50% of the total number of values 0 and values 1, transfers the bitmap data in the first memory as-is to the large capacity memory.

For example, the bitmap data is obtained by rasterizing PDL data that has been input from outside.

Also, the capacity of the first memory and the capacity of the second memory are allocated, and the amount of data accumulated in each memory is determined according to these memory capacities.

According to one embodiment of such a data transfer apparatus of the present invention, a predetermined amount of bitmap data is accumulated in a first memory, a predetermined amount of arrangement-converted bitmap data in which the data arrangement in the X direction and the data arrangement in the Y direction of the predetermined amount of bitmap data are exchanged is accumulated in a second memory, the first number of instances of switching between value 0 and value 1 when transferring bitmap data is compared to the second number of instances of switching between value 0 and value 1 when transferring arrangement-converted bitmap data, and the bitmap data or the arrangement-converted bitmap data with the lesser number of instances of switching is transferred to a large capacity memory. Accordingly, the bitmap data or the arrangement-converted bitmap data with fewer instances of switching between a value 0 and a value 1 is always transferred to the large capacity memory.

Due to few instances of switching between a value 0 and a value 1 in this manner, there are few instances of switching signal levels in a data bus that connects the data transfer apparatus and the large capacity memory, and so power consumption is reduced when transferring data to the large capacity memory.

Also, according to another embodiment of the data transfer apparatus of the present invention, a predetermined amount of bitmap data is accumulated in a first memory, inverted bitmap data obtained by inverting a value 0 and a value 1 in the predetermined amount of bitmap data is accumulated in a second memory, the first number of values 0 in the bitmap data is compared to the second number of values 0 in the inverted bitmap data, and the bitmap data or the inverted bitmap data having the lesser number of values 0 is transferred to the large capacity memory. Accordingly, the data having the lesser number of values 0 is always transferred to the large capacity memory.

Alternatively, according to still another embodiment of the data transfer apparatus of the present invention, a predetermined amount of bitmap data is accumulated in a first memory, and when the number of values 0 in the bitmap data is 50% or more of the total number of values 0 and values 1 in the bitmap data, inverted bitmap data is obtained by inverting the bitmap data via an inverter portion, i.e. by inverting the values 0 and 1 of the bitmap data, and this inverted bitmap data is transferred to a large capacity memory. When the number of values 0 in the bitmap data is less than 50% of the total number of values 0 and 1, the bitmap data is transferred as-is to the large capacity memory. In this case as well, the data having the lesser number of values 0 is always transferred to the large capacity memory.

When the number of values 0 is reduced in this manner, there is a reduction in power consumption when data is transferred to the large capacity memory.

When the corresponding relationship of the respective signal levels to value 0 and value 1 is as desired in a data bus, in the present invention, power consumption is largest when value 0 and value 1 switch, power consumption is next largest when value 0 continues, and the power consumption is least when value 1 continues.

For example, the bitmap data is obtained by rasterizing PDL data that has been input from outside. In a printer controller, often a configuration is adopted in which PDL data is input from a terminal apparatus such as a personal computer, the PDL data is rasterized into bitmap data, and the bitmap data is transferred to a large capacity memory.

Also, a configuration may be adopted in which when respective cache memories are used as a first and second memory, when memory capacities have been allocated, the amount of data accumulated in the memories may be determined according to those capacities.

### BRIEF DESCRIPTION OF THE DRAWINGS

FIG. 1 is a block diagram that shows a network system in which a printer controller is applied, which is a first embodiment of the present invention.

FIG. 2 is a block diagram that schematically shows the configuration of an SOC in the printer controller in FIG. 1.

FIG. 3 shows an example of bitmap data stored in a first cache memory of the SOC in FIG. 2.

FIG. 4 shows an example of arrangement-converted bitmap data stored in a second cache memory of the SOC in FIG. 2.

FIG. 5 is a timing chart that shows signals when transferring the bitmap data in FIG. 3 via a data bus.

FIG. 6 is a timing chart that shows signals when transferring the arrangement-converted bitmap data in FIG. 4 via a data bus.

FIG. 7 is a flowchart that shows a process of data transfer with the SOC in FIG. 2.

FIG. 8 shows an example of bitmap data stored in a first cache memory of an SOC in a printer controller, which is a second embodiment of the present invention.

FIG. 9 shows an example of inverted bitmap data stored in a second cache memory of the SOC in the printer controller of the second embodiment.

FIG. 10 is a timing chart that shows signals when transferring the bitmap data in FIG. 8 via a data bus.

FIG. 11 is a timing chart that shows signals when transferring the inverted bitmap data in FIG. 9 via a data bus.

FIG. 12 is a flowchart that shows a process of data transfer with the SOC in the printer controller of the second embodiment.

FIG. 13 is a block diagram that schematically shows the configuration of an SOC in a printer controller that is a third embodiment of the invention.

### DESCRIPTION OF THE PREFERRED EMBODIMENTS

Hereinafter, embodiments of the present invention will be described in detail with reference to the accompanying drawings.

### First Embodiment

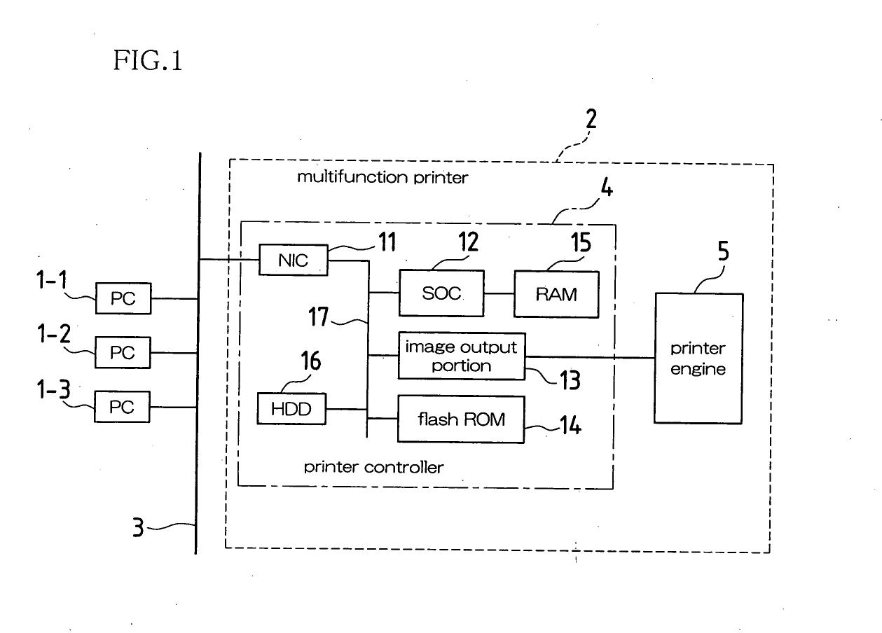

FIG. 1 is a block diagram that shows a network system in which a first embodiment of a data transfer apparatus according to the present invention is applied. In this network system, personal computers 1-1, 1-2, and 1-3, and a multifunction printer 2, are connected to a network 3 such as a LAN, PDL (Page Description Language) data is transferred from a personal computer to the printer 2 via the network 3, and images, text, and the like expressed by the PDL data are printed on recording paper with the printer 2.

The printer 2 is provided with a printer controller 4 and a printer engine 5, and in the printer 2, PDL data from a personal computer is input to the printer controller 4, the PDL data is rasterized to bitmap data with the printer controller 4, the bitmap data is transferred from the printer controller 4 to the printer engine 5, and images, text, and the like expressed by the bitmap data are printed on recording paper with the printer engine 5.

The printer controller 4 corresponds to the data transfer apparatus of the present embodiment, and is provided with, for example, a network interface card 11 connected to the network 3, an SOC (System On Chip) 12, an image output portion 13, a flash ROM 14, a RAM 15, a hard disk 16, and a data bus 17. The network interface card 11 is connected to the network 3, receives PDL data from a personal computer, and transfers the PDL data to the SOC 12 via the data bus 17. When PDL data is input from the network interface card 11, the SOC 12 rasterizes the PDL data to bitmap data, transfers the bitmap data to the RAM 15 via the data bus 17, accumulates the bitmap data in the RAM 15, and furthermore reads out the bitmap data from the RAM 15 and outputs the bitmap data to the image output portion 13. The image output portion 13 transfers/outputs the bitmap data to the printer engine 5.

Incidentally, in the SOC 12, when expanding the PDL data, the bitmap data is temporarily accumulated a predetermined amount at a time in a cache memory within the SOC 12, but the amount of power consumption needed in order to write the bitmap data to and read out the bitmap data from the cache memory is small, and so this power consumption is not regarded as a problem. However, in comparison to this power consumption, a very large amount of power consumption is needed in order to transfer the bitmap data to the RAM 15. This is because data transfer to the RAM 15 is performed via the data bus 17. Moreover, because the amount of bitmap data is large, it is desirable to achieve a reduction in this power consumption.

Therefore, with the printer controller 4 according to the present embodiment, when transferring the bitmap data to the RAM 15 a predetermined amount at a time, a predetermined amount of arrangement-converted bitmap data is obtained in which, for each predetermined amount of bitmap data, the data arrangement in the X direction and the data arrangement in the Y direction are exchanged, and of the bitmap data and the arrangement-converted bitmap data, the data is selected for which there is a lower power consumption when performing data transfer via the data bus 17, and the selected bitmap data or arrangement-converted bitmap data is transferred to the RAM 15 via the data bus 17, thus achieving a reduction in power consumption.

Because the bitmap data expresses images, text, or the like, there is often a bias in the arrangement of binary data that constitutes the bitmap data, and therefore, there may sometimes be a large difference between the number of instances of switching between value 0 and value 1 when transferring/outputting the bitmap data, and the number of instances of switching between value 0 and value 1 when transferring/outputting the arrangement-converted bitmap data. Also, the fewer instances there are of switching between value 0 and value 1, the lower the power consumption needed for transfer via the data bus 17 will be. Accordingly, when the bitmap data or the arrangement-converted bitmap data with fewer instances of switching between value 0 and value 1 is transferred via the data bus 17, it is possible to reduce power consumption.

When a predetermined amount of bitmap data is transferred from the printer controller 4 to the RAM 15 via the data bus 17, a flag value indicating the bitmap data is also transferred, and the predetermined amount of bitmap data is stored along with the flag value in the RAM 15.

Also, when a predetermined amount of arrangement-converted bitmap data is transferred to the RAM 15 via the data bus 17, a flag value indicating the arrangement-converted bitmap data is also transferred, and the predetermined amount of arrangement-converted bitmap data is stored along with the flag value in the RAM 15.

In this manner, a predetermined amount of bitmap data or a predetermined amount of arrangement-converted bitmap data is repeatedly transferred along with respective flag values from the printer controller 4 to the RAM 15, and thus the whole of the bitmap data is stored in the RAM 15 as bitmap data or arrangement-converted bitmap data.

Afterward, a predetermined amount of bitmap data or a predetermined amount of arrangement-converted bitmap data is repeatedly transferred along with respective flag values from the RAM 15 to the SOC 12, and at that time, in the SOC 12, if bitmap data is indicated by a flag value, a predetermined amount of bitmap data is transferred as-is to the printer engine 5 via the image output portion 13, and if arrangement-converted bitmap data is indicated by the flag value, the data arrangement in the X direction and the data arrangement in the Y direction of the predetermined amount of arrangement-converted bitmap data are exchanged again, so that the predetermined amount of arrangement-converted bitmap data is converted to its original state as a predetermined amount of bitmap data, and the predetermined amount of bitmap data is transferred to the printer engine 5 via the image output portion 13. In the printer engine 5, predetermined amounts of bitmap data are sequentially accumulated, and as a result the whole of the bitmap data is accumulated. Then, images, text, and the like expressed by all of this bitmap data are printed on recording paper.

When the corresponding relationship of the respective signal levels to value 0 and value 1 is as desired in the data bus 17, in the present embodiment, power consumption is largest when value 0 and value 1 switch, and the power consumption is less when value 0 or value 1 continues.

Control related to this sort of bitmap data and arrangement-converted bitmap data is performed by the SOC 12 in the printer controller 4.

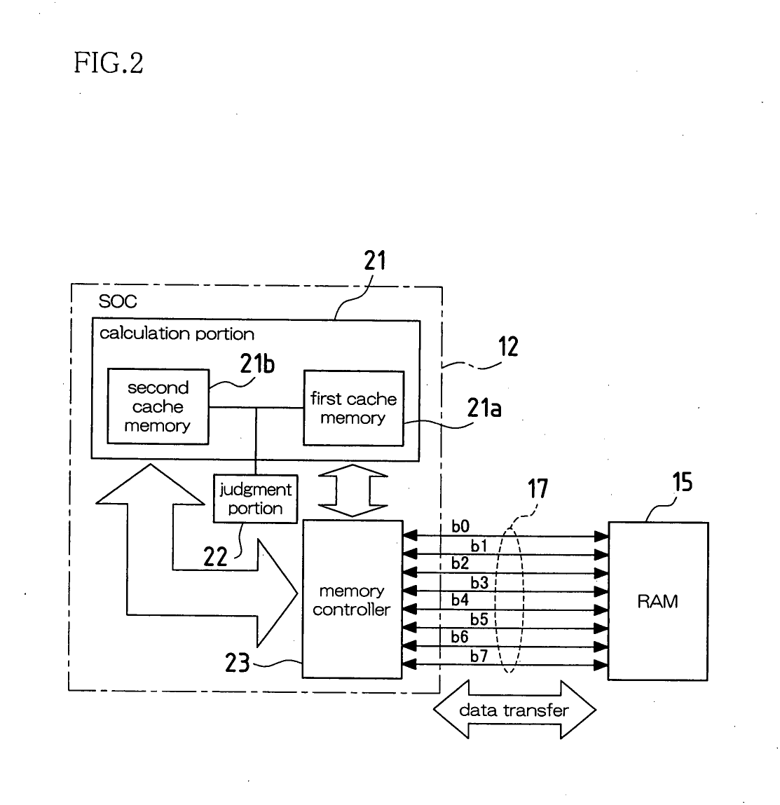

FIG. 2 is a block diagram that schematically shows the configuration of the SOC 12. The SOC 12 is provided with a calculation portion 21, a judgment portion 22, and a memory controller 23. The calculation portion 21 is provided with a first cache memory 21a and a second cache memory 21b, and in the calculation portion 21, PDL data is input from a personal computer, and while rasterizing the PDL data into bitmap data, the bitmap data is stored a predetermined amount at a time in the first cache memory 21a, and in addition, a predetermined amount of arrangement-converted bitmap data is obtained in which, for each data arrangement in the X direction in the predetermined amount of bitmap data, the data arrangement is rearranged from the X direction to the Y direction, and the predetermined amount of arrangement-converted bitmap data is stored in the second cache memory 21b.

The judgment portion 22 obtains the number of instances of switching between value 0 and value 1 when transferring/outputting bitmap data in the first cache memory 21a, obtains the number of instances of switching between value 0 and value 1 when transferring/outputting arrangement-converted bitmap data in the second cache memory 21b, compares both numbers of instances of switching, and selects the bitmap data or the arrangement-converted bitmap data with the lesser number of instances of switching. Then, when the judgment portion 22 selected bitmap data, the judgment portion 22 outputs the bitmap data in the first cache memory 21a to the memory controller 23, and sets a flag value that indicates bitmap data. Or, if the judgment portion 22 selected arrangement-converted bitmap data, the judgment portion 22 outputs the arrangement-converted bitmap data in the second cache memory 21b to the memory controller 23, and sets a flag value that indicates arrangement-converted bitmap data.

If bitmap data in the first cache memory 21a was input to the memory controller 23, this bitmap data and a flag value indicating bitmap data are transferred/output to the RAM 15 via the data bus 17, and if arrangement-converted bitmap data in the second cache memory 21b was input, this arrangement-converted bitmap data and a flag value indicating arrangement-converted bitmap data are transferred/output to the RAM 15 via the data bus 17.

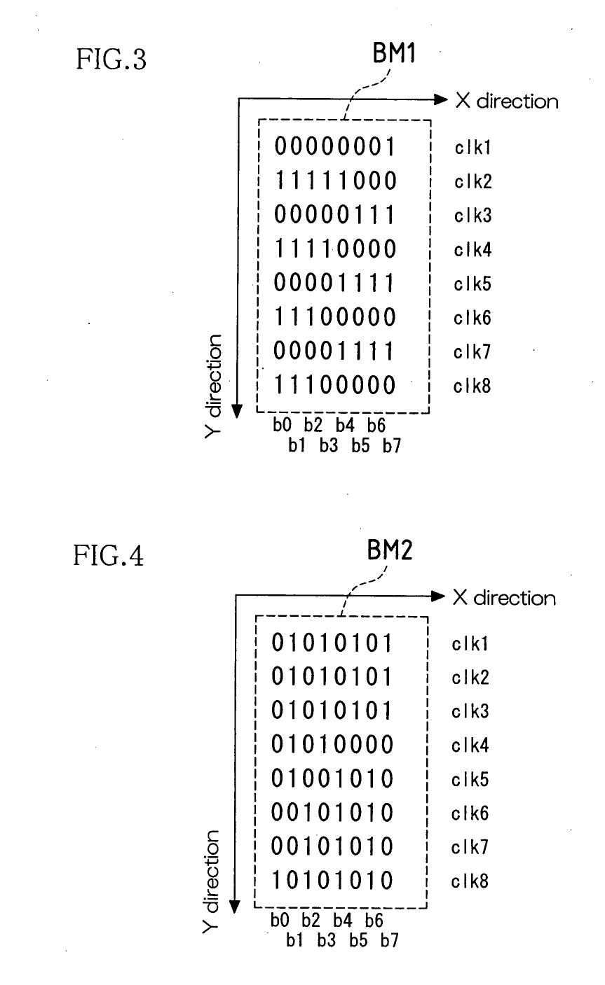

When, for example, bitmap data BM1 having 8 bits in the X direction and 8 bits in the Y direction as shown in FIG. 3 is stored in the first cache memory 21a, the binary data arrangement of this bitmap data BM1 is rearranged from the X direction to the Y direction for each binary data arrangement in the X direction, thus obtaining arrangement-converted bitmap data BM2 as shown in FIG. 4, and this predetermined amount of arrangement-converted bitmap data BM2 is stored in the second cache memory 21b.

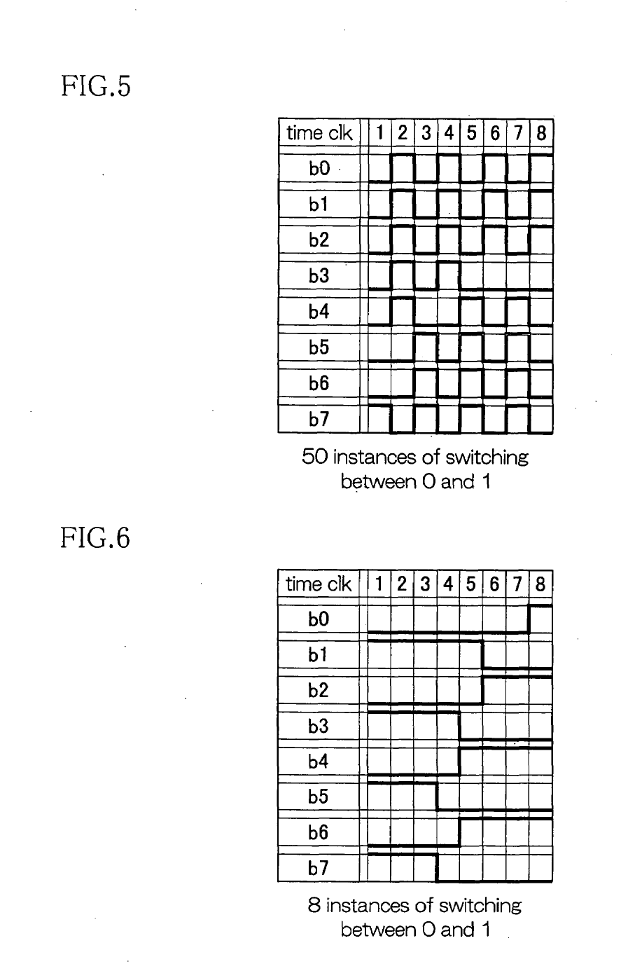

When transferring the bitmap data BM1 in FIG. 3 to the RAM 15, the bitmap data BM1 is transferred from the memory controller 23 to the RAM 15 via the data bus 17 with the 8 bits b0 to b7 of the bitmap data BM1 in parallel. Accordingly, 8 strings of binary data arrangement in the Y direction of this bitmap data BM1 are transferred as the 8 parallel bits b0 to b7 via the data bus 17, and in the data bus 17, as shown in FIG. 5, signals of the 8 parallel bits b0 to b7 are sequentially switched to high level or low level signals.

Likewise, when transferring the arrangement-converted bitmap data BM2 in FIG. 4 to the RAM 15, 8 strings of binary data arrangement in the Y direction of this arrangement-converted bitmap data BM2 are transferred as the 8 parallel bits b0 to b7 via the data bus 17, and in the data bus 17, as shown in FIG. 6, signals of the 8 parallel bits b0 to b7 are sequentially switched to high level or low level signals.

The signals of the 8 parallel bits b0 to b7 in FIG. 5 are switched between high level and low level signals 50 times, and the signals of the 8 parallel bits b0 to b7 in FIG. 6 are switched 8 times. There is a large difference between the number of switches in FIG. 5 and the number of switches in FIG. 6, and the power consumption is lower when the signals of the 8 parallel bits in FIG. 6 are transferred via the data bus 17.

In this case, the arrangement-converted bitmap data in the second cache memory 21b is selected, and this arrangement-converted bitmap data BM2 and a flag value indicating arrangement-converted bitmap data are transferred/output to the RAM 15 via the data bus 17.

In this manner, a predetermined amount of bitmap data or a predetermined amount of arrangement-converted bitmap data is repeatedly transferred along with respective flag values to the RAM 15, and thus the whole of the bitmap data is stored in the RAM 15 as bitmap data or arrangement-converted bitmap data.

Afterward, in the memory controller 23, a predetermined amount of bitmap data or a predetermined amount of arrangement-converted bitmap data is repeatedly transferred along with respective flag values from the RAM 15 to the SOC 12. If arrangement-converted bitmap data is indicated by the flag value, the calculation portion 21 receives the predetermined amount of arrangement-converted bitmap data, converts it to the original predetermined amount of bitmap data, and transfers the predetermined amount of bitmap data to the memory controller 23. If bitmap data is indicated by the flag value, the memory controller 23 transfers a predetermined amount of bitmap data as-is to the printer engine 5 via the image output portion 13, and if arrangement-converted bitmap data is indicated by the flag value, a predetermined amount of arrangement-converted bitmap data is converted to a predetermined amount of bitmap data by the calculation portion 21, and then this predetermined amount of bitmap data is transferred to the printer engine 5 via the image output portion 13. Thus, in the printer engine 5, predetermined amounts of bitmap data are sequentially accumulated, and thus the whole of the bitmap data is transferred.

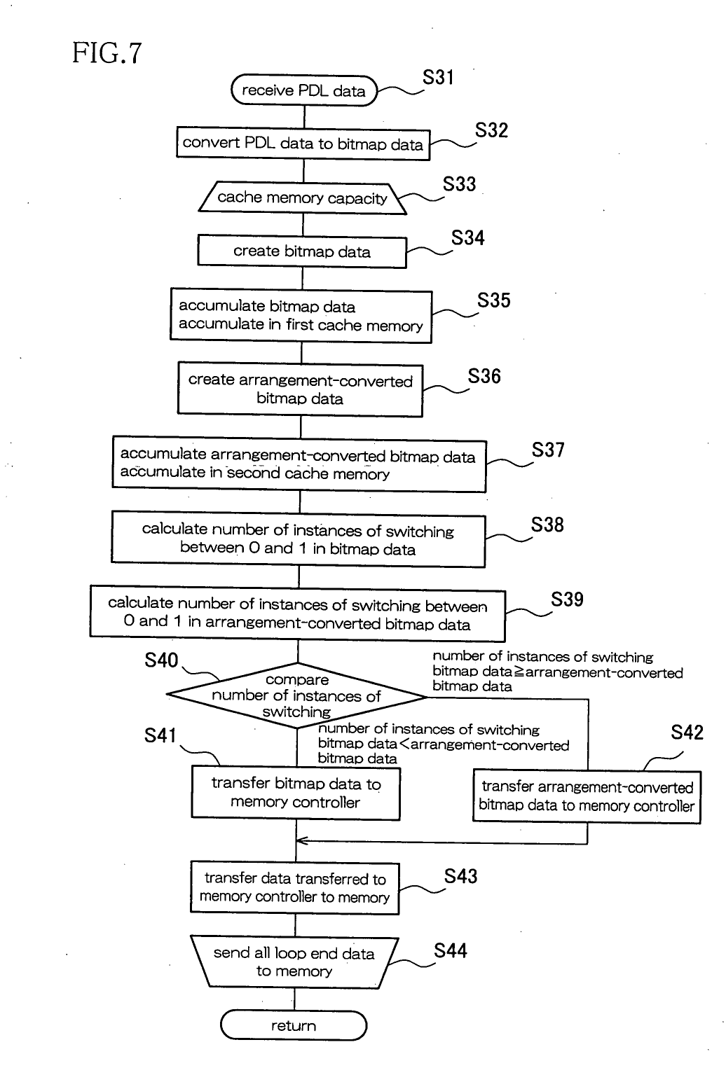

Next is a description of a data transfer process performed by the SOC 12, with reference to the flowchart in FIG. 7.

First, in the calculation portion 21 of the SOC 12, when PDL data is input (Step S31), while rasterizing the PDL data to bitmap data (Step S32), storage capacity is acquired in the first cache memory 21a and the second cache memory 21b that have been allocated to accumulation of bitmap data and arrangement-converted bitmap data, a maximum amount of data that can be accumulated in this storage capacity is set as a predetermined amount (Step S33), this predetermined amount of bitmap data is created (Step S34) and stored in the first cache memory 21a (Step S35), a predetermined amount of arrangement-converted bitmap data is obtained in which the data arrangement in the X direction and the data arrangement in the Y direction of the predetermined amount of bitmap data are exchanged (Step S36), and this predetermined amount of arrangement-converted bitmap data is stored in the second cache memory 21b (Step S37).

Next, the judgment portion 22 obtains the number of instances of switching between value 0 and value 1 when transferring/outputting bitmap data in the first cache memory 21a (Step S38), obtains the number of instances of switching between value 0 and value 1 when transferring/outputting arrangement-converted bitmap data in the second cache memory 21b (Step S39), compares both numbers of instances of switching (Step S40), selects the bitmap data or the arrangement-converted bitmap data with the lesser number of instances of switching, outputs the selected data to the memory controller 23, and sets a flag value for the selected data.

If, for example, there are less instances of switching with the bitmap data, bitmap data is input from the first cache memory 21a to the memory controller 23 (Step S41), and the memory controller 23 transfers/outputs this bitmap data and a flag value that indicates bitmap data to the RAM 15 via the data bus 17 (Steps S43, S44). Or, if there are equal or less instances of switching with the arrangement-converted bitmap data, arrangement-converted bitmap data is input from the second cache memory 21b to the memory controller 23 (Step S42), and the memory controller 23 transfers/outputs this arrangement-converted bitmap data and a flag value that indicates arrangement-converted bitmap data to the RAM 15 via the data bus 17 (Steps S43, S44).

Subsequently, in the same manner, by repeating Steps S31 to S44, a predetermined amount of bitmap data or a predetermined amount of arrangement-converted bitmap data is repeatedly transferred along with respective flag values to the RAM 15, and thus the whole of the bitmap data is stored in the RAM 15 as bitmap data or arrangement-converted bitmap data.

In this manner, in the present embodiment, a predetermined amount of bitmap data is accumulated in the first cache memory 21a, a predetermined amount of arrangement-converted bitmap data is accumulated in the second cache memory 21b, the number of instances of switching between value 0 and value 1 when transferring/outputting bitmap data is compared to the number of instances of switching between value 0 and value 1 when transferring/outputting arrangement-converted bitmap data, and the bitmap data or the arrangement-converted bitmap data with the lesser number of instances of switching is transferred/output to the RAM 15; thus, the power consumption when transferring/outputting data to the RAM 15 via the data bus 17 is reduced.

### Second Embodiment

Next is a description of a second embodiment of the data transfer apparatus according to the present invention. The data transfer apparatus of the present embodiment corresponds to the printer controller 4 of the multifunction printer 2 in the network system shown in FIG. 1. The SOC 12 of this printer controller 4 has the configuration shown in FIG. 2.

With the printer controller 4 according to the present embodiment, instead of selectively using a predetermined amount of bitmap data and a predetermined amount of arrangement-converted bitmap data as described above, a predetermined amount of inverted bitmap data is obtained in which, for each predetermined amount of bitmap data, values 0 and 1 in the bitmap data are inverted, and of the bitmap data and the inverted bitmap data, the data is selected for which there is a lower power consumption when performing data transfer via the data bus 17, and the selected bitmap data or inverted bitmap data is transferred to the RAM 15 via the data bus 17, thus achieving a reduction in power consumption.

Because the bitmap data expresses images, text, or the like, there may sometimes be a large difference between the number of values 0 and the number of values 1 in the bitmap data. Also, the fewer values 0 there are, the lower the power consumption needed for transfer via the data bus 17 will be. Accordingly, it is possible to reduce power consumption if, when the number of values 0 in the bitmap data is less than the number of values 1, the bitmap data is transferred as-is via the data bus 17, and when the number of values 0 in the bitmap data is equal to or greater than the number of values 1, inverted bitmap data obtained by inverting the values 0 and the values 1 of the bitmap data is transferred via the data bus 17.

Here, instead of comparing the number of values 0 in the bitmap data to the number of values 1 in the bitmap data, the number of values 0 in the bitmap data is compared to the number of values 0 in the inverted bitmap data, and the bitmap data or the inverted bitmap data with fewer values 0 is transferred.

When a predetermined amount of bitmap data is transferred from the printer controller 4 to the RAM 15 via the data bus 17, a flag value indicating bitmap data is also transferred, and the predetermined amount of bitmap data is stored along with the flag value in the RAM 15.

Or, when a predetermined amount of inverted bitmap data is transferred to the RAM 15 via the data bus 17, a flag value indicating inverted bitmap data is also transferred, and the predetermined amount of inverted bitmap data is stored along with the flag value in the RAM 15.

In this manner, a predetermined amount of bitmap data or a predetermined amount of inverted bitmap data is repeatedly transferred along with respective flag values from the printer controller 4 to the RAM 15, and thus the whole of the bitmap data is stored in the RAM 15 as bitmap data or inverted bitmap data.

Afterward, a predetermined amount of bitmap data or a predetermined amount of inverted bitmap data is repeatedly transferred along with respective flag values from the RAM 15 to the SOC 12, and at that time, in the SOC 12, if bitmap data is indicated by a flag value, a predetermined amount of bitmap data is transferred as-is to the printer engine 5 via the image output portion 13, and if inverted bitmap data is indicated by the flag value, a predetermined amount of inverted bitmap data is again inverted to obtain a predetermined amount of bitmap data, and the predetermined amount of bitmap data is transferred to the printer engine 5 via the image output portion 13. In the printer engine 5, predetermined amounts of bitmap data are sequentially accumulated, thus accumulating the whole of the bitmap data, and images, text, and the like expressed by all of this bitmap data are printed on recording paper.

When the corresponding relationship of the respective signal levels to value 0 and value 1 is as desired in the data bus 17, in the present embodiment, power consumption is larger at the time of value 0 than at the time of value 1.

This sort of control related to bitmap data and inverted bitmap data is performed by the SOC 12 in the printer controller 4.

In the calculation portion 21, PDL data is input from a personal computer, and while rasterizing the PDL data into bitmap data, the bitmap data is stored a predetermined amount at a time in the first cache memory 21a, and in addition, a predetermined amount of inverted bitmap data is obtained by inverting the predetermined amount of bitmap data, and the predetermined amount of inverted bitmap data is stored in the second cache memory 21b.

The judgment portion 22 obtains the number of values 0 in the bitmap data in the first cache memory 21a and the number of values 0 in the inverted bitmap data in the second cache memory 21b, compares these values, and selects the bitmap data or the inverted bitmap data with fewer values 0. Then, when the judgment portion 22 selected bitmap data, the judgment portion 22 outputs the bitmap data in the first cache memory 21a to the memory controller 23, and sets a flag value that indicates bitmap data. Or, if the judgment portion 22 selected inverted bitmap data, the judgment portion 22 outputs the inverted bitmap data in the second cache memory 21b to the memory controller 23, and sets a flag value that indicates inverted bitmap data.

If bitmap data in the first cache memory 21a was input to the memory controller 23, this bitmap data and a flag value indicating bitmap data are transferred/output to the RAM 15 via the data bus 17, and if inverted bitmap data in the second cache memory 21b was input, this inverted bitmap data and a flag value indicating inverted bitmap data are transferred/output to the RAM 15 via the data bus 17.

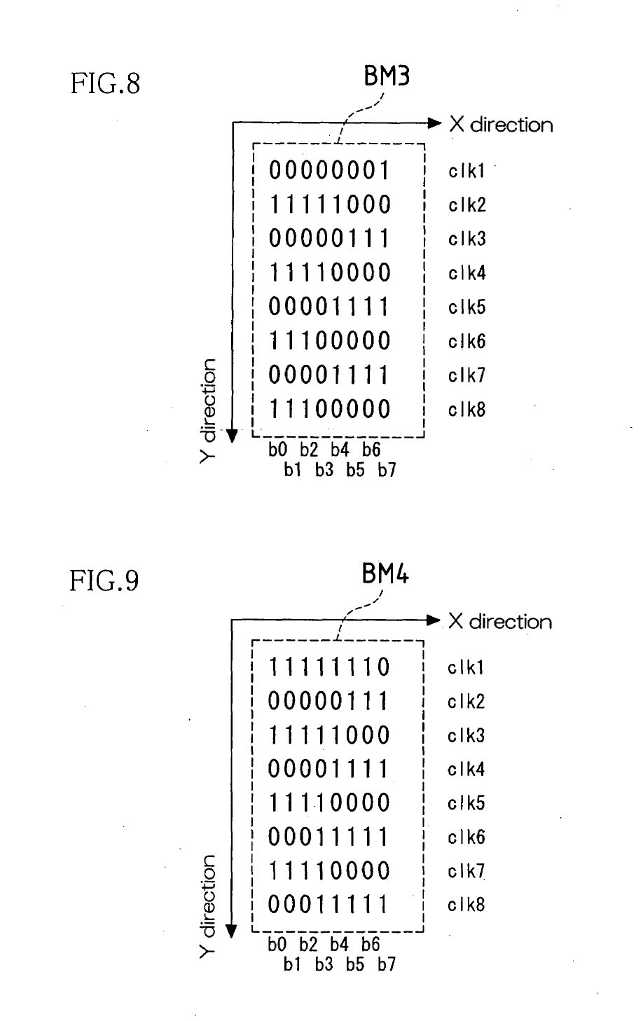

When, for example, bitmap data BM3 having 8 bits in the X direction and 8 bits in the Y direction as shown in FIG. 8 is stored in the first cache memory 21a, this bitmap data BM3 is inverted, thus obtaining inverted bitmap data BM4 as shown in FIG. 9, and this predetermined amount of inverted bitmap data BM4 is stored in the second cache memory 21b.

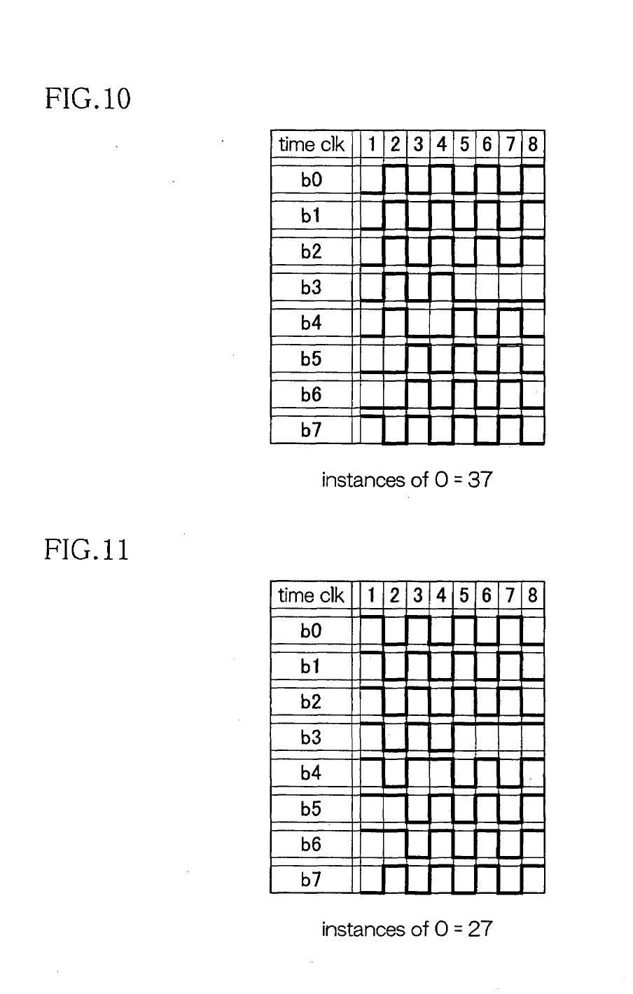

When transferring the bitmap data BM3 in FIG. 8 to the RAM 15, 8 strings of binary data arrangement in the Y direction of the bitmap data BM3 are transferred as the 8 parallel bits b0 to b7 via the data bus 17, and in the data bus 17, as shown in FIG. 10, signals of the 8 parallel bits b0 to b7 are sequentially switched to high level or low level signals.

Likewise, when transferring the inverted bitmap data BM4 in FIG. 9 to the RAM 15, 8 strings of binary data arrangement in the Y direction of the inverted bitmap data BM4 are transferred as the 8 parallel bits b0 to b7 via the data bus 17, and in the data bus 17, as shown in FIG. 11, signals of the 8 parallel bits b0 to b7 are sequentially switched to high level or low level signals.

There are 37 low level signals (corresponding to value 0) among the signals of the 8 parallel bits b0 to b7 in FIG. 10, and there are 27 low level signals (corresponding to value 0) among the signals of the 8 parallel bits b0 to b7 in FIG. 11. Thus the power consumption when performing transfer via the data bus 17 will be lower for the signals of the 8 parallel bits b0 to b7 in FIG. 11.

In this case, the inverted bitmap data BM4 in the second cache memory 21b is selected, and this inverted bitmap data BM4 and a flag value indicating inverted bitmap data are transferred/output to the RAM 15 via the data bus 17.

In this manner, a predetermined amount of bitmap data or a predetermined amount of inverted bitmap data is repeatedly transferred along with respective flag values to the RAM 15, and thus the whole of the bitmap data is stored in the RAM 15 as bitmap data or inverted bitmap data.

Afterward, in the memory controller 23, a predetermined amount of bitmap data or a predetermined amount of inverted bitmap data is repeatedly transferred along with respective flag values from the RAM 15 to the SOC 12. If inverted bitmap data is indicated by the flag value, the calculation portion 21 receives the predetermined amount of inverted bitmap data, converts it to the predetermined amount of bitmap data, and transfers the predetermined amount of bitmap data to the memory controller 23. If bitmap data is indicated by the flag value, the memory controller 23 transfers a predetermined amount of bitmap data as-is to the printer engine 5 via the image output portion 13, and if inverted bitmap data is indicated by the flag value, a predetermined amount of inverted bitmap data is converted to a predetermined amount of bitmap data by the calculation portion 21, and then this predetermined amount of bitmap data is transferred to the printer engine 5 via the image output portion 13.

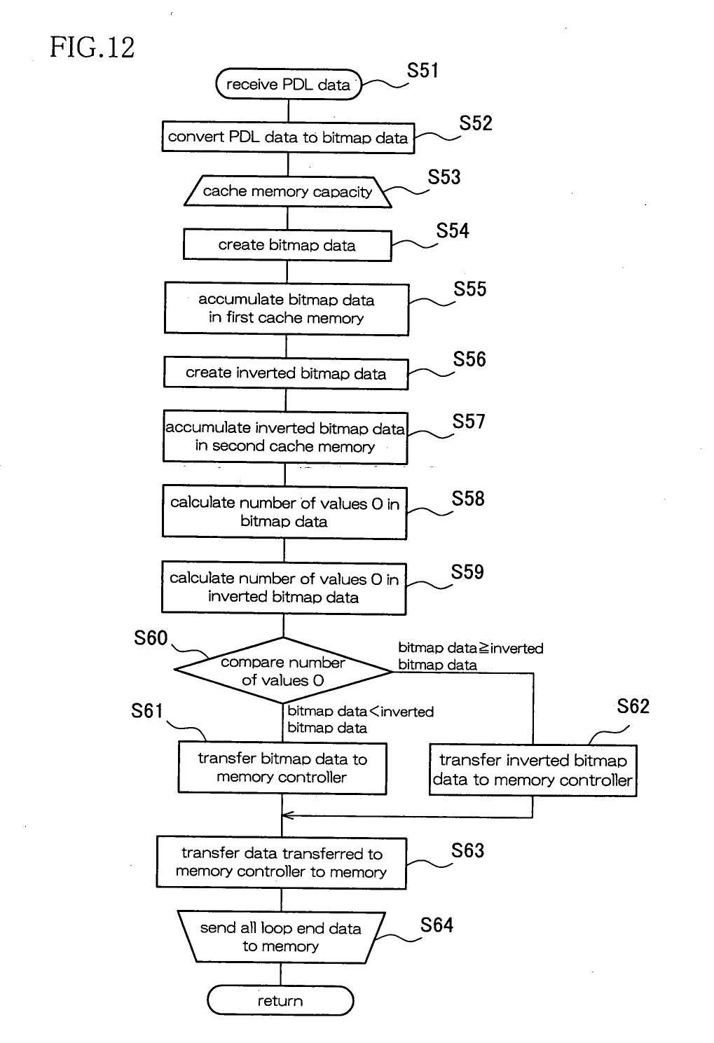

Next is a description of a data transfer process performed by the SOC 12, with reference to the flowchart in FIG. 12.

First, in the calculation portion 21 of the SOC 12, when PDL data is input (Step S51), while rasterizing the PDL data to bitmap data (Step S52), storage capacity is acquired in the first cache memory 21a and the second cache memory 21b that have been allocated to accumulation of bitmap data and inverted bitmap data, a maximum amount of data that can be accumulated in this storage capacity is set as a predetermined amount (Step S53), this predetermined amount of bitmap data is created (Step S54) and stored in the first cache memory 21a (Step S55), a predetermined amount of inverted bitmap data is obtained by inverting the predetermined amount of bitmap data (Step S56), and this predetermined amount of inverted bitmap data is stored in the second cache memory 21b (Step S57).

Next, the judgment portion 22 obtains the number of values 0 of the bitmap data in the first cache memory 21a (Step S58), obtains the number of values 0 in the inverted bitmap data in the second cache memory 21b (Step S59), compares both numbers of values (Step S60), selects the bitmap data or the inverted bitmap data with the lesser number of values 0, outputs the selected data to the memory controller 23, and sets a flag value for the selected data.

For example, bitmap data is selected and input to the memory controller 23 from the first cache memory 21a (Step S61), and this bitmap data and a flag value indicating bitmap data are transferred/output to the RAM 15 via the data bus 17 (Steps S63 and S64). Or, inverted bitmap data is selected and input to the memory controller 23 from the second cache memory 21b (Step S62), and this inverted bitmap data and a flag value indicating inverted bitmap data are transferred/output to the RAM 15 via the data bus 17 (Steps S63 and S64).

Subsequently, in the same manner, by repeating Steps S51 to S64, a predetermined amount of bitmap data or a predetermined amount of inverted bitmap data is repeatedly transferred along with respective flag values to the RAM 15, and thus the whole of the bitmap data is stored in the RAM 15 as bitmap data or inverted bitmap data.

In this manner, in the present embodiment, the number of values 0 in the bitmap data is compared to the number of values 0 in the inverted bitmap data, and the bitmap data or the inverted bitmap data with fewer values 0 is transferred to the RAM 15, so the power consumption when transferring/outputting data to the RAM 15 via the data bus 17 is reduced.

### Third Embodiment

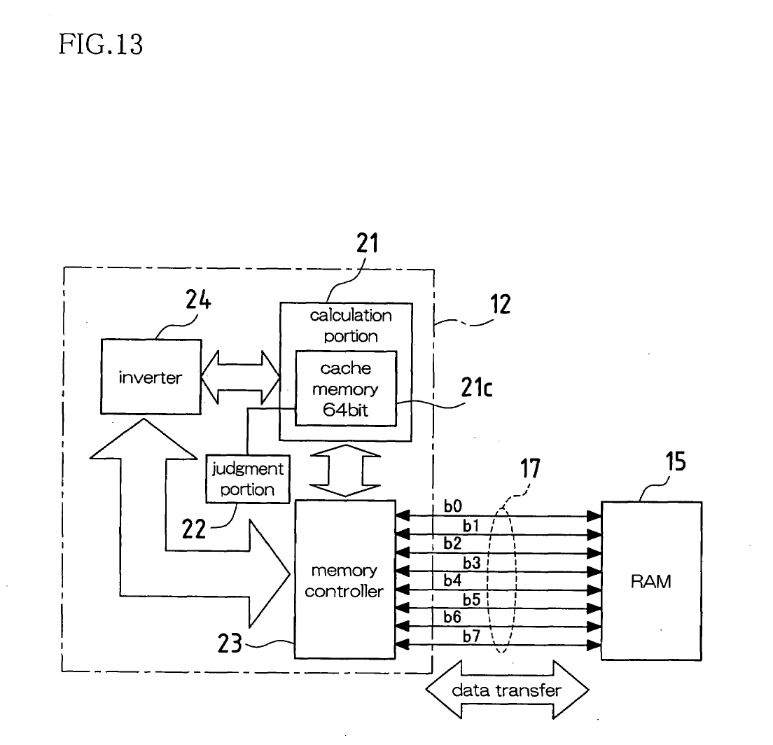

Next is a description of a third embodiment of the data transfer apparatus according to the present invention. The data transfer apparatus of the present embodiment corresponds to the printer controller 4 of the multifunction printer 2 in the network system shown in FIG. 1. The SOC 12 of this printer controller 4 is configured as shown in FIG. 13.

With the printer controller 4 according to the present embodiment, when the number of values 0 in a predetermined amount of bitmap data is 50% or more of the total number of values 0 and 1 in the predetermined amount of bitmap data, a predetermined amount of inverted bitmap data is obtained by inverting the predetermined amount of bitmap data via an inverter 24, i.e. by inverting the values 0 and 1 of the bitmap data, and this predetermined amount of inverted bitmap data is transferred/output to the RAM 15. When the number of values 0 in the predetermined amount of bitmap data is less than 50% of the total number of values 0 and 1 in the predetermined amount of bitmap data, the predetermined amount of bitmap data is transferred/output as-is to the RAM 15.

Accordingly, in the present embodiment as well, as in the above second embodiment, the bitmap data or the inverted bitmap data with fewer values 0 is transferred.

When a predetermined amount of bitmap data is transferred from the printer controller 4 to the RAM 15 via the data bus 17, a flag value indicating bitmap data is also transferred, and the predetermined amount of bitmap data is stored along with the flag value in the RAM 15.

Or, when a predetermined amount of inverted bitmap data is transferred to the RAM 15 via the data bus 17, a flag value indicating inverted bitmap data is also transferred, and the predetermined amount of inverted bitmap data is stored along with the flag value in the RAM 15.

In this manner, a predetermined amount of bitmap data or a predetermined amount of inverted bitmap data is repeatedly transferred along with respective flag values from the printer controller 4 to the RAM 15, and thus the whole of the bitmap data is stored in the RAM 15 as bitmap data or inverted bitmap data.

Afterward, a predetermined amount of bitmap data or a predetermined amount of inverted bitmap data is repeatedly transferred along with respective flag values from the RAM 15 to the SOC 12, and at that time, in the SOC 12, a predetermined amount of bitmap data is transferred as-is to the printer engine 5, or a predetermined amount of inverted bitmap data is again inverted to obtain a predetermined amount of bitmap data, and the predetermined amount of bitmap data is transferred to the printer engine 5.

Next is a description of control performed by the SOC 12 shown in FIG. 13, specifically control related to bitmap data and inverted bitmap data.

In the calculation portion 21, PDL data is input from a personal computer, and while rasterizing the PDL data into bitmap data, the bitmap data is stored a predetermined amount at a time in a cache memory 21c.

The judgment portion 22 judges whether or not the number of values 0 in the bitmap data in the cache memory 21c is 50% or more of the total number of values 0 and 1 in the bitmap data, and if the number of values 0 in the bitmap data is not 50% or more of the total number of values 0 and 1, the bitmap data in the cache memory 21c is output as-is to the memory controller 23, and a flag value that indicates bitmap data is set. If the number of values 0 in the bitmap data is 50% or more of the total number of values 0 and 1, the bitmap data in the cache memory 21c is inverted via the inverter 24, the inverted bitmap data is output to the memory controller 23, and a flag value that indicates inverted bitmap data is set.

If bitmap data was input to the memory controller 23, this bitmap data and a flag value indicating bitmap data are transferred/output to the RAM 15 via the data bus 17, and if inverted bitmap data was input, this inverted bitmap data and a flag value indicating inverted bitmap data are transferred/output to the RAM 15 via the data bus 17.

Then, a predetermined amount of bitmap data or a predetermined amount of inverted bitmap data is repeatedly transferred along with respective flag values to the RAM 15, and thus the whole of the bitmap data is stored in the RAM 15 as bitmap data or inverted bitmap data.

In this manner, in the present embodiment as well, the bitmap data or the inverted bitmap data with fewer values 0 is transferred/output to the RAM 15, so the power consumption when transferring/outputting data to the RAM 15 via the data bus 17 is reduced.

Note that the present invention is not limited to the embodiments above, and can be modified in various ways. For example, a printer controller was described as an example of a data transfer apparatus according to the present invention, but the present invention is also applicable in various other apparatuses that transfer a bitmap memory to an external memory via a data bus.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A data transfer apparatus that transfers bitmap data that is a collection of binary data to a large capacity memory, the data transfer apparatus comprising:
a first memory in which a predetermined amount of the bitmap data is accumulated;
a second memory in which arrangement-converted bitmap data is accumulated, the arrangement-converted bitmap data being obtained by, for each of a data arrangement in an X direction in the predetermined amount of bitmap data, rearranging the data arrangement from the X direction to a Y direction;
a calculation portion that obtains a first number of instances of switching between a value 0 and a value 1 when transferring bitmap data in the first memory, and obtains a second number of instances of switching between the value 0 and the value 1 when transferring arrangement-converted bitmap data in the second memory;
a transfer portion that, of the first number of instances of switching for the bitmap data in the first memory and the second number of instances of switching for the arrangement-converted bitmap data in the second memory that were obtained by the calculation portion, selects the lesser number of instances of switching, and transfers the bitmap data or the arrangement-converted bitmap data having the lesser number of instances of switching to the large capacity memory.

2. The data transfer apparatus according to claim 1, wherein the bitmap data is obtained by rasterizing PDL data that has been input from outside.

3. The data transfer apparatus according to claim 1, wherein the capacity of the first memory and the capacity of the second memory are allocated, and the amount of data accumulated in each memory is determined according to these memory capacities.

4. A data transfer apparatus that transfers bitmap data that is a collection of binary data to a large capacity memory, the data transfer apparatus comprising:
a first memory in which a predetermined amount of the bitmap data is accumulated;
a second memory in which inverted bitmap data is accumulated, the inverted bitmap data being obtained by inverting a value 0 and a value 1 in the predetermined amount of bitmap data;
a calculation portion that obtains a first number of values 0 in the bitmap data in the first memory and a second number of values 0 in the inverted bitmap data in the second memory;
a transfer portion that, of the first number of values 0 in the bitmap data in the first memory and the second number of values 0 for the inverted bitmap data in the second memory that were obtained by the calculation portion, selects the lesser number of values 0, and transfers the bitmap data or the inverted bitmap data having the lesser number of values 0 to the large capacity memory.

5. The data transfer apparatus according to claim 4, wherein the bitmap data is obtained by rasterizing PDL data that has been input from outside.

6. The data transfer apparatus according to claim 4, wherein the capacity of the first memory and the capacity of the second memory are allocated, and the amount of data accumulated in each memory is determined according to these memory capacities.

7. A data transfer apparatus that transfers bitmap data that is a collection of binary data to a large capacity memory, the data transfer apparatus comprising:
a first memory in which a predetermined amount of the bitmap data is accumulated;
an inverter portion that inverts a value 0 and a value 1 in the predetermined amount of bitmap data;
a calculation portion that obtains a number of values 0 in the bitmap data in the first memory;
a transfer portion that, when the number of values 0 in the bitmap data in the first memory obtained by the calculation portion is 50% or more of the total number of values 0 and values 1 in the bitmap data, transfers the bitmap data in the first memory to the large capacity memory via the inverter portion, and when the number of values 0 is less than 50% of the total number of values 0 and values 1, transfers the bitmap data in the first memory as-is to the large capacity memory.

8. The data transfer apparatus according to claim 7, wherein the bitmap data is obtained by rasterizing PDL data that has been input from outside.
